(19) United States
(12) Patent Application Publication
(10) Pub. No.: US 2023/0179059 A1
(43) Pub. Date: Jun. 8, 2023

(54) MOTOR AND BEARING OUTER RING FIXING UNIT

(71) Applicant: FANUC CORPORATION, Yamanashi (JP)

(72) Inventor: Taku OOHARA, Yamanashi-ken (JP)

(21) Appl. No.: 17/911,696

(22) PCT Filed: Mar. 19, 2021
(86) PCT No.: PCT/JP2021/011380

§ 371 Date: Sep. 15, 2022

(30) Foreign Application Priority Data
Mar. 24, 2020 (JP) 2020-051997

(51) Int. Cl. H02K 5/173; F16C 35/07

(52) U.S. Cl. CPC H02K 5/1732; F16C 35/07

(57) ABSTRACT

Provided are a motor and a bearing outer ring fixing unit that can prevent a bearing outer ring from shifting in the axial direction. The motor of an embodiment is provided with: a first member attached to a housing and supporting one end surface side of the outer ring of a bearing; and a second member attached to the first member and supporting the other end surface side of the outer ring of the bearing. The outer ring is fastened by the first member and the second member.

### TECHNICAL FIELD

The present invention relates to a motor and a bearing outer ring fixing unit.

### BACKGROUND ART

In JP 2008-301609 A, a motor is disclosed having a shaft (motor shaft), a housing through which the shaft is inserted, and bearings (ball bearings) that rotatably support the shaft with respect to the housing. Inner rings of the bearings disclosed in JP 2008-301609 A are fixed to the shaft by being press-fitted onto the shaft. On the other hand, outer rings of the bearings disclosed in JP 2008-301609 A are accommodated in openings formed in the housing, and are biased at all times in an axial direction of the shaft.

### SUMMARY OF THE INVENTION

However, the outer rings of the bearings disclosed in JP 2008-301609 A are not fixed to the housing. For this reason, in the event of an abnormality such as excessive vibrations being applied to the motor, a force in excess of the biasing force that biases the outer rings acts in the axial direction of the shaft, whereby a case may occur in which the outer rings shift in the axial direction with respect to the inner rings. In this case, there is a concern that the bearings may be damaged.

Thus, an object of the present invention is to provide a motor and a bearing outer ring fixing unit, which are capable of suppressing shifting or displacement of the outer rings of the bearings in an axial direction.

One aspect of the present invention is characterized by a motor including a shaft, a housing through which the shaft is inserted, and a bearing configured to rotatably support the shaft with respect to the housing, the motor including: a first member installed in the housing, and configured to support a side of one end surface of an outer ring of the bearing; and a second member attached to the first member, and configured to support a side of another end surface of the outer ring, wherein the outer ring is fastened to the first member and the second member.

Another aspect of the present invention is characterized by a bearing outer ring fixing unit that fixes, to a housing, an outer ring of a bearing configured to rotatably support a shaft with respect to the housing through which the shaft is inserted, the bearing outer ring fixing unit including: a first member installed in the housing, and configured to support a side of one end surface of the outer ring of the bearing; and a second member attached to the first member, and configured to support a side of another end surface of the outer ring, wherein the outer ring is fastened to the first member and the second member.

According to the aspects of the present invention, the outer ring can be gripped by the first member and the second member, and as a result, shifting or displacement of the outer ring of the bearing in the axial direction can be suppressed.

### BRIEF DESCRIPTION OF THE DRAWINGS

FIG. 1 is a cross-sectional view showing a motor according to an embodiment;

FIG. 2 is a cross-sectional view showing a bearing outer ring fixing unit according to the embodiment together with one portion of the motor;

FIG. 3 is a cross-sectional view showing a bearing outer ring fixing unit according to a first exemplary modification together with one portion of a motor; and

FIG. 4 is a cross-sectional view showing a bearing outer ring fixing unit according to a second exemplary modification together with one portion of a motor.

### DESCRIPTION OF THE INVENTION

Hereinafter, a preferred embodiment of the present invention will be presented and described in detail below with reference to the accompanying drawings.

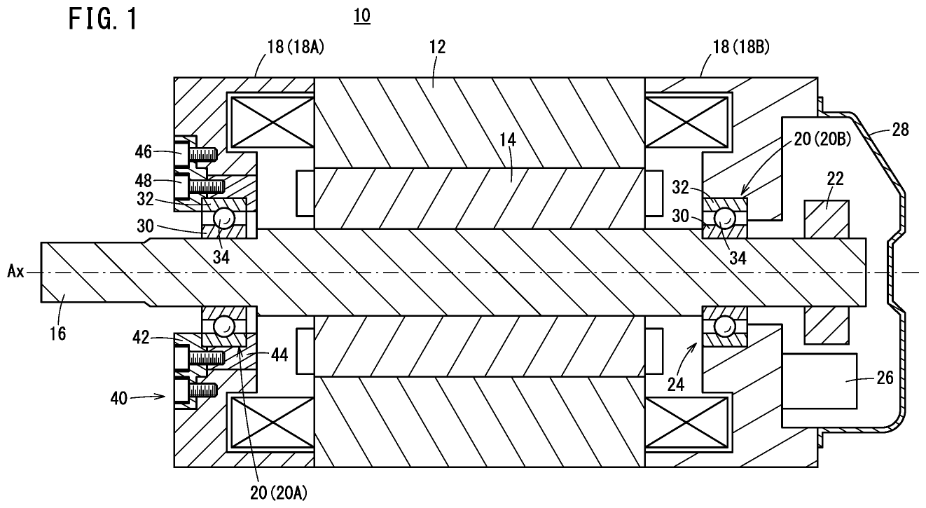

FIG. 1 is a cross-sectional view showing a motor 10 according to an embodiment. The motor 10 includes a stator 12, a rotor 14, a shaft 16, a housing 18, and bearings 20.

The stator 12 serves to generate a force for rotating the rotor 14. The stator 12 is formed in a cylindrical shape and is arranged on an outer circumferential side of the rotor 14.

The rotor 14 is rotated using a force generated by the stator 12. The rotor 14 is arranged in a cylindrical inner portion of the cylindrically shaped stator 12, and is arranged on an inner circumferential side of the stator 12. The rotor 14 is rotated due to an interaction with a magnetic field generated in the stator 12 in accordance with the current that flows through the stator 12.

The shaft 16 is rotated in conjunction with rotation of the rotor 14. The shaft 16 is formed in a rod shape, and is mounted in the rotor 14. A rotary axis Ax of the shaft 16 coincides with a central axis of the stator 12 and the rotor 14. In this instance, according to the present embodiment, one end side of the shaft 16 is defined as a front side, and another end side of the shaft 16 is defined as a rear side. A body to be detected 22, which is used in order to detect the rotation of the shaft 16, is disposed on the rear side of the shaft 16. The body to be detected 22, for example, is a gear disposed on an outer circumferential surface of the shaft 16.

The housing 18 is a box-shaped body having a hole through which the shaft 16 is inserted. The entire stator 12 may be accommodated in the housing 18, or as shown in FIG. 1, a front side end portion and a rear side end portion of the stator 12 may be accommodated in the housing 18 separately. Moreover, according to the present embodiment, the housing 18 serves to separately accommodate the front side end portion and the rear side end portion of the stator 12. Hereinafter, the housing 18 that covers the front side end portion of the stator 12 is referred to as a front side housing 18A, and the housing 18 that covers the rear side end portion of the stator 12 is referred to as a rear side housing 18B.

The front side housing 18A is provided on the stator 12 in a manner so as to cover a front side end surface of the rotor 14, in a state of being placed in contact with an end surface of the stator 12 on the front side of the shaft 16. The rear side housing 18B is provided on the stator 12 in a manner so as to cover a rear side end surface of the rotor 14, in a state of being placed in contact with an end surface of the stator 12 on the rear side of the shaft 16.

A recess 24 into which an outer ring 32 of one of the bearings 20 is fitted is formed in a surface on an inner circumferential side of the rear side housing 18B. A rotation sensor 26 for detecting a rotational speed of the shaft 16 is provided on a surface on an outer circumferential side of the rear side housing 18B. The rotation sensor 26 detects the rotational speed of the shaft 16 on the basis of the body to be detected 22 which is disposed on the rear side of the shaft 16. The body to be detected 22 and the rotation sensor 26 are covered by a lid member 28 which is mounted on a rear end surface of the rear side housing 18B.

The bearings 20 serve to rotatably support the shaft 16 with respect to the housing 18. According to the present embodiment, one bearing 20, which supports the shaft 16 that extends to the front side from the rotor 14, and another bearing 20, which supports the shaft 16 that extends to the rear side from the rotor 14, are provided. Hereinafter, the bearing 20 that supports the shaft 16 that extends to the front side from the rotor 14 is referred to as a front side bearing 20A, and the bearing 20 that supports the shaft 16 that extends to the rear side from the rotor 14 is referred to as a rear side bearing 20B.

The front side bearing 20A and the rear side bearing 20B each include an inner ring 30, the outer ring 32, and rolling bodies 34 arranged between the inner ring 30 and the outer ring 32. The inner rings 30 of the front side bearing 20A and the rear side bearing 20B are fixed onto the outer circumferential surface of the shaft 16, for example, by being press-fitted onto the shaft 16. The outer ring 32 of the front side bearing 20A is fixed to the front side housing 18A by a bearing outer ring fixing unit 40, and the outer ring 32 of the rear side bearing 20B is installed in the rear side housing 18B by being fitted into the recess 24 of the rear side housing 18B. It should be noted that the outer ring 32 of the rear side bearing 20B is biased at all times from the rear side toward the front side by a non-illustrated biasing member such as a spring that is arranged between the rear side housing 18B and the outer ring 32.

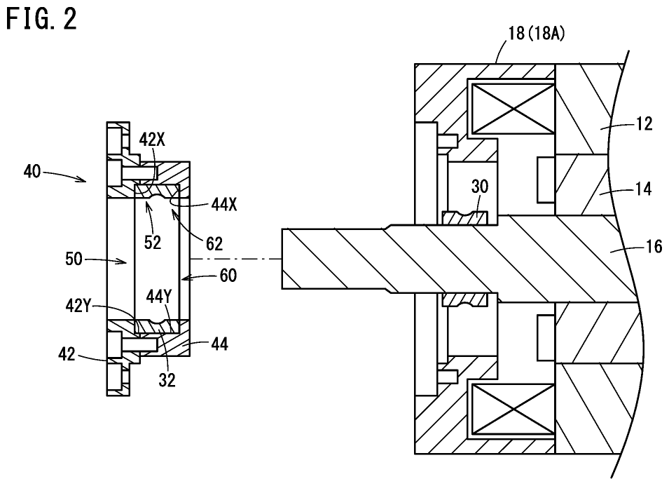

The bearing outer ring fixing unit 40 is a unit for fixing the outer ring 32 to the housing 18, and includes a first member 42 and a second member 44. FIG. 2 is a cross-sectional view showing the bearing outer ring fixing unit 40 together with one portion of the motor 10.

The first member 42 serves to support a side of one end surface of the outer ring 32. The first member 42, by being mounted on the front side housing 18A, is fixed to the front side housing 18A (refer to FIG. 1). The first member 42 may include screw holes therein corresponding to screw holes that are formed in the front side housing 18A along the axial direction of the outer ring 32, and the first member 42 may be mounted on the front side housing 18A by bolts 46 that are screwed into the screw holes. In FIG. 1, a case is shown in which the first member 42 is mounted by the bolts 46.

The first member 42 includes a through hole 50 through which the shaft 16 is inserted, and an accommodating hole 52 for accommodating a portion of the outer ring 32. The accommodating hole 52 extends from an end surface of the first member 42 on the second member 44 side toward an end surface thereof on the opposite side, and has an outer diameter that is larger than an outer diameter of the outer ring 32.

The first member 42 includes a first wall surface 42X for restraining a front side end surface of the outer ring 32 that is accommodated in the accommodating hole 52, and a second wall surface 42Y for restraining a portion of an outer circumferential surface of the outer ring 32. According to the present embodiment, the first wall surface 42X is placed in contact with the front side end surface of the outer ring 32 that is accommodated in the accommodating hole 52. According to the present embodiment, the second wall surface 42Y is placed in contact with an outer circumferential surface of the outer ring 32, from the front side end surface up to a location midway along a rear side end surface of the outer ring 32 that is accommodated in the accommodating hole 52.

The second member 44 serves to support a side of another end surface of the outer ring 32. The second member 44, by being attached to the first member 42, is fixed to the first member 42. The second member 44 may include screw holes therein corresponding to the screw holes that are formed in the first member 42 along the axial direction of the outer ring 32, and the second member 44 may be attached to the second member 44 by bolts 48 that are screwed into the screw holes. In FIG. 1 and FIG. 2, a case is shown in which the second member 44 is attached by the bolts 48.

The second member 44 includes a through hole 60 through which the shaft 16 is inserted, and an accommodating hole 62 for accommodating a portion of the outer ring 32. The accommodating hole 62 extends from an end surface of the second member 44 on the first member 42 side toward an end surface thereof on the opposite side, and has an outer diameter that is larger than the outer diameter of the outer ring 32.

The second member 44 includes a first wall surface 44X for restraining the rear side end surface of the outer ring 32 that is accommodated in the accommodating hole 62, and a second wall surface 44Y for restraining a portion of an outer circumferential surface of the outer ring 32. According to the present embodiment, the first wall surface 44X is placed in contact with the rear side end surface of the outer ring 32 that is accommodated in the accommodating hole 62. According to the present embodiment, the second wall surface 44Y is placed in contact with the outer circumferential surface of the outer ring 32, from the rear side end surface up to a location midway along the front side end surface of the outer ring 32 that is accommodated in the accommodating hole 62.

The outer ring 32 is fastened to the first member 42 and the second member 44. According to the present embodiment, the outer ring 32 is fastened to the first member 42 and the second member 44 by screwing the bolts 48 from a front side end surface of the first member 42 into the second member 44. As a result, the outer ring 32 can be gripped by the first member 42 and the second member 44, and as a result, shifting or displacement of the outer ring 32 in the axial direction can be suppressed.

The outer ring 32 may be fastened to the first member 42 and the second member 44 by means of fastening members other than the bolts 48. According to the present embodiment, since the bolts 48 are shared in common as members for fixing the second member 44 to the first member 42, and as members for fastening the first member 42 and the second member 44 to each other, the number of component parts is reduced.

Herein, an example of a method for mounting the bearing outer ring fixing unit 40 will briefly be described. The through hole 60 of the second member 44 is inserted over a portion of the shaft 16 that protrudes from the front side housing 18A, and the outer ring 32 is accommodated in the accommodating hole 62 of the inserted second member 44. At this time, the rolling bodies 34 are arranged between the inner ring 30 that is fixed to the shaft 16 and the outer ring 32. Next, so as to bring about a state in which the outer ring 32 is accommodated in the accommodating hole 52 of the first member 42, the through hole 50 of the first member 42 is inserted over the shaft 16, and the outer ring 32 is fastened to the first member 42 and the second member 44 by the bolts 48. Next, the first member 42 is fixed to the front side housing 18A by the bolts 46.

In the foregoing manner, the bearing outer ring fixing unit 40 is fixed to the front side housing 18A. In other words, the first member 42 and the second member 44 are capable of being attached to and detached from the front side housing 18A. Accordingly, as compared to a case in which the first member 42 and the second member 44 are incapable of being attached to and detached from the front side housing 18A, it becomes easier to install the outer ring 32 in the front side housing 18A. Further, it becomes easy to improve the surface roughness and the like of the wall surfaces (the first wall surfaces 42X and 44X, the second wall surfaces 42Y and 44Y) of the first member 42 and the second member 44 that support the outer ring 32.

### EXEMPLARY MODIFICATIONS

The above-described embodiment may be modified in the following manner.

### Exemplary Modification 1

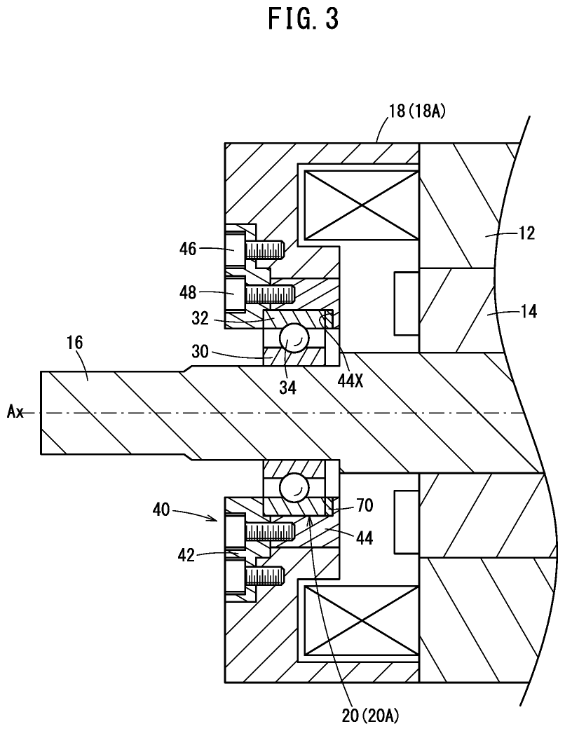

FIG. 3 is a cross-sectional view showing the bearing outer ring fixing unit 40 according to an Exemplary Modification 1 together with one portion of the motor 10. In FIG. 3, the same reference numerals are applied to constituent elements that are equivalent to the constituent elements described in the embodiment. Moreover, in the present exemplary modification, descriptions that are duplicative of those of the embodiment will be omitted.

The present exemplary modification differs from the embodiment in that an adjustment plate 70 is newly provided.

The adjustment plate 70 serves to adjust an axial thickness of the outer ring 32. The adjustment plate 70 is arranged between the outer ring 32 and the second member 44. Therefore, according to the embodiment, the first wall surface 44X of the second member 44 is placed in contact with the rear side end surface of the outer ring 32, whereas according to the present exemplary modification, the first wall surface 44X is placed in contact with the adjustment plate 70. The outer ring 32 is restrained by the first wall surface 44X via the adjustment plate 70.

Instead of being arranged between the outer ring 32 and the second member 44, or in addition to being arranged between the outer ring 32 and the second member 44, the adjustment plate 70 may be arranged between the outer ring 32 and the first member 42. In other words, the adjustment plate 70 may be arranged between at least one of the first member 42 or the second member 44, and the outer ring 32. As a result, even if the axial thickness of the outer ring 32 changes in accordance with, for example, a change in the type of the outer ring 32, the degree to which the outer ring 32 is fastened can be kept the same.

Moreover, the adjustment plate 70 may be formed in an annular shape or may be formed in a plate shape. In the case that the adjustment plate 70 is formed in a plate shape, a plurality of the adjustment plates 70 may be arranged at intervals in the axial direction of the outer ring 32, between the outer ring 32 and the second member 44.

### Exemplary Modification 2

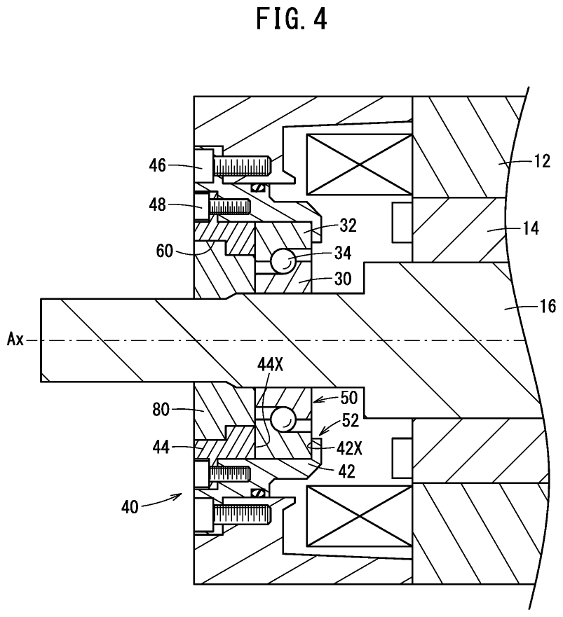

FIG. 4 is a cross-sectional view showing the bearing outer ring fixing unit 40 according to an Exemplary Modification 2 together with one portion of the motor 10. In FIG. 4, the same reference numerals are applied to constituent elements that are equivalent to the constituent elements described in the embodiment. Moreover, in the present exemplary modification, descriptions that are duplicative of those of the embodiment will be omitted.

In the present exemplary modification, the mode by which the first member 42 and the second member 44 support the outer ring 32 differs from that in the embodiment. More specifically, according to the embodiment, the first member 42 supports the front side end surface of the outer ring 32, and the second member 44 supports the rear side end surface of the outer ring 32. In contrast thereto, according to the present exemplary modification, the first member 42 supports the rear side end surface of the outer ring 32, and the second member 44 supports the front side end surface of the outer ring 32.

According to the present exemplary modification, in the same manner as in the embodiment, the first member 42 includes the through hole 50 and the accommodating hole 52. On the other hand, the second member 44 includes the through hole 60, but does not include the accommodating hole 62. In the second member 44 of the present exemplary modification, the end surface on the first member 42 side becomes the first wall surface 44X.

Further, in the present exemplary modification, the order in which the first member 42 and the second member 44 are mounted differs from that in the embodiment. More specifically, the through hole 50 of the first member 42 is inserted over the shaft 16 that protrudes from the front side housing 18A, and the inserted first member 42 is fixed to the front side housing 18A by the bolts 46. Next, the outer ring 32 is accommodated in the accommodating hole 52 of the first member 42. At this time, the rolling bodies 34 are arranged between the outer ring 32 and the inner ring 30 that is fixed to the shaft 16. Next, the through hole 60 of the second member 44 is inserted over the shaft 16, and in a state in which the first wall surface 44X of the second member 44 is placed in contact with the front side end surface of the outer ring 32, the outer ring 32 is fastened to the first member 42 and the second member 44 by the bolts 48.

In this manner, also in the present exemplary modification, in the same manner as in the embodiment, the outer ring 32 can be gripped by the first member 42 and the second member 44, and as a result, shifting or displacement of the outer ring 32 in the axial direction can be suppressed.

Moreover, according to the present exemplary modification, a lid member 80 that covers the front end portion of the front side bearing 20A is provided between the second member 44 and the shaft 16. The lid member 80 may be omitted. Further, the lid member 80 may be provided between the second member 44 according to the embodiment and the shaft 16.

### Exemplary Modification 3

The outer ring 32 of the rear side bearing 20B may be installed in the rear side housing 18B by the bearing outer ring fixing unit 40. In the case of the present exemplary modification, as in the embodiment, the recess 24 into which the outer ring 32 of the front side bearing 20A is fitted is formed on the surface on the inner circumferential side of the front side housing 18A, and the outer ring 32 is fitted into the recess 24. In this case, the outer ring 32 of the front side bearing 20A is biased at all times from the front side toward the rear side by a biasing member such as a spring that is arranged between the front side housing 18A and the outer ring 32.

### Exemplary Modification 4

The outer ring 32 may be fastened to the first member 42 and the second member 44 by screwing the bolts 48 from a rear side end surface of the second member 44 into the first member 42. Also in the case that the bolts 48 are screwed from the rear side end surface of the second member 44 into the first member 42, in the same manner as in the case of the above-described embodiment in which the bolts 48 are screwed from the front side end surface of the first member 42 into the second member 44, the outer ring 32 is capable of being fastened to the first member 42 and the second member 44.

### INVENTIONS

The first invention and the second invention are described hereinafter as inventions that are capable of being grasped from the above-described embodiment and the exemplary modifications thereof. Moreover, the reference numerals used in the above-described embodiment and the exemplary modifications thereof are appended parenthetically to the constituent elements of the inventions to be described hereinafter.

### First Invention

The first invention is characterized by the motor (10) including the shaft (16), the housing (18) through which the shaft (16) is inserted, and the bearing (20) that rotatably supports the shaft (16) with respect to the housing (18). The motor (10) is equipped with the first member (42) that is installed in the housing (18) and supports the side of one end surface of the outer ring (32) of the bearing (20), and the second member (44) that is attached to the first member (42) and supports the side of the other end surface of the outer ring (32). The outer ring (32) is fastened to the first member (42) and the second member (44).

In accordance with these features, the outer ring (32) can be gripped by the first member (42) and the second member (44), and as a result, shifting or displacement of the outer ring (32) in the axial direction can be suppressed.

The first member (42) and the second member (44) may be attached to and detached from the housing (18). In accordance with this feature, as compared to a case in which the first member (42) and the second member (44) are incapable of being attached to and detached from the housing (18), it becomes easier to install the outer ring (32) in the housing (18). Further, it becomes easy to improve the surface roughness and the like of the wall surfaces of the first member (42) and the second member (44) that support the outer ring (32).

The motor (10) may further be equipped with the adjustment plate (70) that is arranged between at least one of the first member (42) or the second member (44) and the outer ring (32), and that serves to adjust the axial thickness of the outer ring (32). In accordance with this feature, even if the axial thickness of the outer ring (32) changes in accordance with, for example, a change in the type of the outer ring (32), the degree to which the outer ring (32) is fastened can be kept the same.

### Second Invention

The second invention is characterized by the bearing outer ring fixing unit (40) for fixing, to the housing (18), the outer ring (32) of the bearing (20) that rotatably supports the shaft (16) with respect to the housing (18) through which the shaft (16) is inserted. The bearing outer ring fixing unit (40) is equipped with the first member (42) that is installed in the housing (18) and supports the side of one end surface of the outer ring (32) of the bearing (20), and the second member (44) that is attached to the first member (42) and supports the side of the other end surface of the outer ring (32). The outer ring (32) is fastened to the first member (42) and the second member (44).

In accordance with these features, the outer ring (32) can be gripped by the first member (42) and the second member (44), and as a result, shifting or displacement of the outer ring (32) in the axial direction can be suppressed.

The bearing outer ring fixing unit (40) may further be equipped with the adjustment plate (70) that is arranged between at least one of the first member (42) or the second member (44) and the outer ring (32), and that serves to adjust the axial thickness of the outer ring (32). In accordance with this feature, even if the axial thickness of the outer ring (32) changes in accordance with, for example, a change in the type of the outer ring (32), the degree to which the outer ring (32) is fastened can be kept the same.

1. A motor including a shaft, a housing through which the shaft is inserted, and a bearing configured to rotatably support the shaft with respect to the housing, the motor comprising:
a first member installed in the housing, and configured to support a side of one end surface of an outer ring of the bearing; and
a second member attached to the first member, and configured to support a side of another end surface of the outer ring,
wherein the outer ring is fastened to the first member and the second member.

2. The motor according to claim 1, wherein the first member and the second member are configured to be attached to and detached from the housing.

3. The motor according to claim 1, further comprising an adjustment plate arranged between at least one of the first member or the second member and the outer ring, and configured to adjust an axial thickness of the outer ring.

4. A bearing outer ring fixing unit that fixes, to a housing, an outer ring of a bearing configured to rotatably support a shaft with respect to the housing through which the shaft is inserted, the bearing outer ring fixing unit comprising:
a first member installed in the housing, and configured to support a side of one end surface of the outer ring of the bearing; and
a second member attached to the first member, and configured to support a side of another end surface of the outer ring,
wherein the outer ring is fastened to the first member and the second member.

5. The bearing outer ring fixing unit according to claim 4, further comprising an adjustment plate arranged between at least one of the first member or the second member and the outer ring, and configured to adjust an axial thickness of the outer ring.
